(19) United States
(12) Patent Application Publication
(10) Pub. No.: US 2019/0066181 A1
(43) Pub. Date: Feb. 28, 2019

(54) Food and retail product packaging information exchange mobile application system

(71) Applicant: Industry Innovations Corporation, Placentia, CA (US)

(72) Inventor: Martin J. Victorin, Oceanside, CA (US)

(21) Appl. No.: 16/107,797

(22) Filed: Aug. 21, 2018

Related U.S. Application Data
(60) Provisional application No. 62/548,897, filed on Aug. 22, 2017.

(51) Int. Cl. G06Q 30/06; G06Q 10/08; G06K 19/06; G06F 17/30

(52) U.S. Cl. CPC G06Q 30/0623; G06F 17/30879; G06K 19/06037; G06Q 10/087

(57) ABSTRACT

Disclosed a food and retail industry specific mobile device and software application that (a) computer-aidedly connects to electronic chip tags (such as, but not limited to, RFID) and/or nonelectronic printed tags (such as, but not limited to UPC barcodes and/or QR codes) that are found on consumer packaged goods (referred to as “CPG”) and (b) provides the related and automated services relevant to products bearing these tags.

### CROSS-REFERENCE TO RELATED APPLICATIONS

This application claims the benefit of U.S. Provisional Application No. 62/548,897, filed Aug. 22, 2017.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of food and retail product packaging information exchange and mobile device software application systems.

### Background of the Invention

Nearly every single food and retail product has inherent variable and invariable information that is valuable to a consumer. For instance, purchase price, discounts, expiration dates, safety or recall alerts, product make-up or ingredients, other item information, and the like can be important to a consumer before, during or after the purchase of a product. Such information can be used by: (1) a consumer for inventory planning (i.e., shopping lists) and pickup or purchase mapping (e.g., store or product locating); (2) a product vendor or supplier for marketing and sales efforts as well as in stock availability.

Typically, products are tagged on their labels with bar codes that can communicate basic invariable information about the product to a consumer. These on-product labels/codes are often hard or impossible to read by shopper/consumers and only contain invariable information about the product, like product makeup or ingredients, expiration dates, or nutritional content. Variable information, like in-stock or inventory location for the product, pricing information of the product, discounts or rewards for the product, or safety and recall alerts for the product also generally serve the consumers but cannot be ascertained from the on-product label with UPC barcode. Thus, existing on-product labeling or coding of information does not fully serve the needs of food and retail consumers.

Existing on-product labeling or coding also does not fully serve the needs of a product supplier or retailer because the information cannot be conveyed to a consumer until the product is in-hand and only invariable information can be provided. Further, on-product labeling serves no utility for inviting or enticing a consumer to a specific retail location that carries the product or to use the product in a particular way or fashion. So, on-product labeling or coding, taken alone, does not serve all the needs of a food or other retail supplier or vendor.

In the age of the internet, global communication networks, and the ubiquity of mobile computing (e.g., via smart cellular phones or tablet computers), information can be communicated in real-time to consumers/shoppers by retailers, suppliers, or vendors and vice versa. For instance some mobile devices feature scanners for computer aided reading of on-product codes or labels. Mobile and geography-specific marketing techniques are also known to offer product discounts to consumers based on proximity to in-stock availability of products. In other situations, news feeds or social networking can deliver information (like discounts or safety alerts) to a consumer by a vendor or supplier of products. Despite such technological advances, no single technology exists that provides a food and retail industry specific mobile application that connects to on-product tags (electrical (e.g., RFID) and/or printed (e.g., UPC barcodes or QR codes) that are found on consumer packaged goods (“CPG”) which then provide the following related services: product expiration date notifications: recall/safety alerts; general product information; product discounts and/or purchase rewards; digital shopping lists; item location services; direct marketing by CPG manufactures to consumers; and product related social networking.

### SUMMARY OF THE INVENTION

In view of the foregoing, an object of this specification is to disclose a food and retail industry specific mobile device software application that (a) computer-aidedly connects to electronic chip tags (such as, but not limited to, RFID) and/or nonelectronic printed tags (such as, but not limited to UPC barcodes and/or QR codes) that are found on consumer packaged goods (referred to as “CPG”) and (b) provides the related automated and interactive services relevant to products bearing these tags. In a preferred embodiment, the services may be: expiration date notifications; recall/safety alerts; displaying of general product information in visual ways, including but not limited to, product demonstration videos; displaying product digital coupons and discounts typically found in newspapers; providing a consumer purchase rewards and loyalty points program; logging of a consumer's product inventory and, relatedly, the compiling of digital shopping lists based on a consumer's logged product inventory; geo-locating of a product; direct marketing by CPG manufacturers to consumers; and product related social networking.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a diagram of the disclosed technology.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

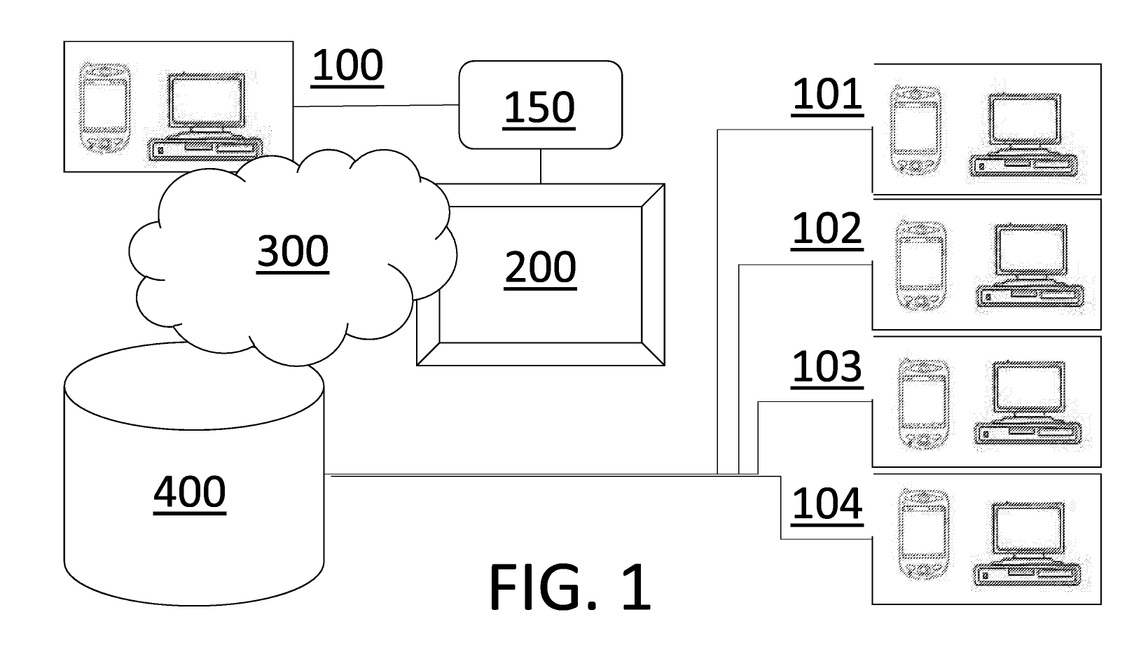

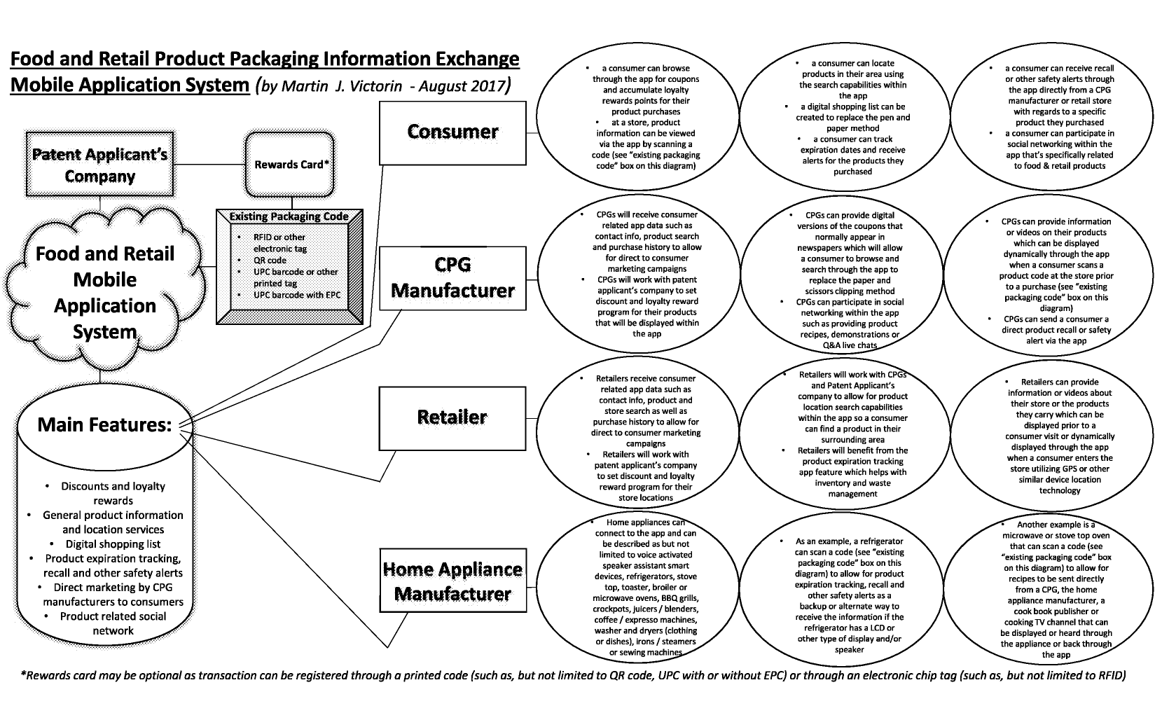

Disclosed may be a food and retail industry specific mobile device software application that (a) computer-aidedly connects to electronic chip tags (such as, but not limited to, RFID) and/or nonelectronic printed tags (such as, but not limited to UPC barcodes and/or QR codes) that are found on consumer packaged goods (referred to as “CPG”) and (b) provides the related automated and interactive services relevant to products bearing these tags. FIG. 1 is a diagram of a mobile device software application infrastructure. The general features of the disclosed technology is described with reference to FIG. 1.

As shown, the technology in a preferred embodiment, involves a host 100, a consumer mobile computing device 101, a CPG manufacturer computing device 102, a retailer computing device 103, and a home appliance device 104 (such as a smart refrigerator). As shown, the host 100 is communicably coupled to a cloud or server based database 400 via a food and retail mobile application system 300. Suitably, the database is configured to receive information via the system 300 associated with or relevant to existing product packaging codes or chips 200 (e.g., RFID or other electronic tag, QR Codes, UPC barcodes or other printed tags, or UPC barcodes with EPCs) and/or rewards card 150. As shown the database 400 may suitably receive the information associated with or relevant to the codes/chips 200 or rewards card 150 directly from the codes via the mobile application system 300 (e.g., from mobile users) or via the host 100 through the system 300. Still referring to FIG. 1, information to or from the database may be sent and received over a two-way network to the consumer computing device 101, a CPG manufacturer computing device 102, a retailer computer device 103, and a home appliance device 104. In a preferred embodiment, the system 300 may be configured to accomplish on the electrical devices 101, 102, 103, 104: expiration date notifications; recall/safety alerts; displaying of general product information in visual ways, including but not limited to, product demonstration videos; displaying product digital coupons and discounts typically found in newspapers; providing a consumer purchase rewards and loyalty points program; logging of a consumer's product inventory and, relatedly, the compiling of digital shopping lists based on a consumer's logged product inventory; geo-locating of a product; direct marketing by CPG manufacturers to consumers; and product related social networking.

Still referring to FIG. 1, the consumer mobile computing device 101 may suitably be outfitted with hardware and software so that a user of the device 101 may via the device 101, database 400, and system 300: (a) browse the database for coupons or rewards based on previous product purchases; (b) receive on a display of the device 101 product information via scanning of a product barcode or chip 200 (e.g., while at the store); (c) geo-locate products in close proximity to the device 101; (d) create a digital shopping list that can replace the pen and paper method; (e) log purchased products, track expiration dates of the purchased products, and/or receive safety or other alerts for purchased products; (f) obtain messages or alerts directly from the CPG manufacturer 102, retailer 103, or home appliance 104 over the system with regard to a specific product purchased; and, (g) participate in social networking via the system where the networking is specifically related to the food and retail product.

In a preferred embodiment, a software application for a mobile device 101 can be downloaded by a consumer. In a suitable mobile device 101, an optical or wireless input receiver, like a camera, UPC barcode and/or RFID chip reader can be included whereby the mobile application software plus electronic device may be configured for reading on-product labels (whether electronic or printed). Preferably, the consumer mobile computing device 101 further contains computer memory and wireless communication hardware and the software is configured to electively (a) capture and store information obtained from the optical or wireless input receiver and (b) communicate the information to a cloud or server based database 400. In a preferred embodiment, once downloaded by the consumer to their electronic device 101, they can register a profile with their own personal information (e.g., contact information). Such information may be suitably stored in the database 400 and associated with the consumer profile.

Yet still referring to FIG. 1, a CPG manufacturer computing device 102 may suitably be outfitted with hardware and software so that a user of the device 102 may, via the device 102, database 400, and system 300: (i) receive consumer purchase and activity related data (including purchase history) from the consumer electronic device 101 via the system 300 for consumer targeted marketing; (ii) communicate with the host 100 over the system to set discount and loyalty reward programs for products wherein the discount and loyalty programs are stored in the database 400; (iii) provide digital coupons (that would otherwise appear in newspapers) via the system 300 to consumers 101 where the consumers 101 can peruse and use the coupons (i.e., as a digital replacement for the paper and scissor coupon methods); (iv) participate in social networking via the system (e.g., receiving product recipes, viewing product demonstrations, and participating in live-chats with CPG manufacturers); (v) provide information or videos on their products to the database 400 for dynamic display on the consumer's mobile computing device 101 whenever a code or tag 200 of a product is scanned via the device 101; and (vi) send a consumer 101 a safety or recall alert for their purchased product.

Once again referring to FIG. 1, a retailer computer device 103 may suitably be outfitted with hardware and software so that a user of the device 103 may, via the device 103, database 400, and system 300: A) receive a consumers profile information and product shopping or search history from the database 400 so that the retailer 103 can directly market to the consumer; B) communicate with the host 100 over the system to set discount and loyalty reward programs for products wherein the discount and loyalty programs are stored in the database 400; C) communicate with the host 100 and CPG manufacturer 102 to enable product location searches over the system 300 via a consumer mobile computing device 101 whereby they can geolocate products in proximity to the device 101; D) log product inventory and track expiration of the product inventory for inventory management and for avoidance of waste via communication of data from the retailer 103 after scanning a product's barcode/chip 200 to the database 400 through the system 300; and E) provide information or videos of their retail location or products to the database 400 for dynamic display on the consumer mobile computing device 101 whenever a code or chip 200 of a product is scanned via the device 101 or whenever the device 101 enters the retail location.

Finally, FIG. 1 shows a home appliance computer device 104 that may include, but should not be limited to, speaker assistant smart devices, refrigerators, stove tops, toasters, broilers or microwave ovens, BBQ grills, crockpots, juicers/blenders, coffee/expresso machines, washer and drying (clothing or dishes), irons/steamers, or sewing machines. In a preferred embodiment, the device 104 may suitably be outfitted with hardware and software so that a user of the device 104 may, via the device 104, database 400, and system 300, alert the consumer 101 that a product near or used by the device 104 is expired or access other information related to the product. For example, a refrigerator 104 can scan a code and obtain information from the database 400 and display the same on a display to allow for product expiration tracking, recall and other safety alerts as an alternative to viewing the alerts through the device 101. For another example, a microwave or stove top 104 can scan a code or chip on a product and receive information from the database 400, consumer 101, CPG manufacturer 102, or retailer 103 over the system 300 and be displayed. In one embodiment, the information received and displayed by the device is provided by a cookbook publisher, a cooking TV channel or the like.

In practice, the consumer's profile will algorithmically (via software on their mobile device and in the cloud or server) allow that consumer to (a) get information about optically or electronically scanned products and (b) locate the products in their surrounding area at participating stores as well as find out which products are on sale by browsing digital coupons which can replace the printed newspaper ads provided by CPG manufacturers. Suitably, the mobile device software application may be configured to enable a consumer to create a digital shopping list on the mobile device to be stored in the cloud or on a server. In a preferred embodiment, the digital shopping list may replace the traditional pen and paper method.

In one embodiment, a consumer may, while on location at a store, use the mobile device software application to scan a printed code or electronic chip and receive associated information about the product displayed on the mobile device. In a preferred embodiment, the received information on the mobile device would help with making a purchasing decision. Also, participating stores can find out that a consumer is currently at their location, via the software application, and provide real-time marketing or digital coupons, which can be applied at the store's POS checkout. A product retailer can accept a rewards card (appearing similar in size to a credit card) that is linked to the app and their POS checkout system which will register the purchasing data and be utilized later for expiration date notifications, recall/safety alerts, and rewards points. In some cases, if a store does not participate, then a mobile phone can manually scan a unique printed code which may be inside the packaging or under the cap of the purchased product to “check” it into the app. Alternatively, products can be “checked in” via an electronic chip tag. Alternatively, a digital refrigerator or pantry device with manual or electronic scanning capability can read the unique printed code or electronic chip tag from a purchased product and check it into the app and be utilized later for expiration date notifications, recall/safety alerts and rewards points. CPG manufacturers can use the app for digital marketing by way of product advertising, posting food recipes as well as providing consumers with samples of newly released or future products. Finally, the app can provide a social networking feature to connect individuals who favor particular products via chat messaging, video and/or message forums.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. For instance, rewards cards and programs can be optional as transaction can be registered through a printed code (such as but not limited to OR codes, UPC with or Without EPC) or through an electronic chip tag (such as but not limited to RFI©). Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A food and retail product packaging information exchange mobile application system.

2. A food and retail industry specific mobile device software application that (a) computer-aidedly connects to electronic chip tags and/or nonelectronic printed tags (such as, but not limited to UPC barcodes and/or QR codes) that are found on consumer packaged goods and (b) provides the related and automated services relevant to products bearing these tags.

3. The mobile device software application of FIG. 2 wherein the services may be: expiration date notifications; recall/safety alerts; displaying of general product information in visual ways, including but not limited to, product demonstration videos; displaying product digital coupons and discounts typically found in newspapers; providing a consumer purchase rewards and loyalty points program; logging of a consumer's product inventory and, relatedly, the compiling of digital shopping lists based on a consumer's logged product inventory; geo-locating of a product; direct marketing by CPG manufacturers to consumers; and product related social networking.
